(19) United States
(12) Patent Application Publication
(10) Pub. No.: US 2007/0029361 A1
(43) Pub. Date: Feb. 8, 2007

(54) Rack for carrying trailer-bike

(76) Inventor: Feza Dag Oktay, Needham, MA (US)

Correspondence Address: OKTAY ENTERPRISES INTERNATIONAL, 2807 MULBERRY COURT, POUGHKEEPSIE, NY, 12603, US

(21) Appl. No.: 11/500,550

(22) Filed: Aug. 7, 2006

Related U.S. Application Data
(60) Provisional application No. 60/706,231, filed on Aug. 8, 2005.

(51) Int. Cl. B60R 9/048

(52) U.S. Cl. 224/324; 224/924

(57) ABSTRACT

Rack for carrying a trailer-bike. The rack has a conversion member that may readily be used to convert an existing bicycle rack to a trailer-bike rack to transport a trailer-bike on the roof of a vehicle, such as an automobile. The conversion member may easily be removed and/or folded to reconvert the trailer-bike rack to an ordinary rack. The rack may also be configured to transport the trailer-bike along with the towing bicycle together on the same convertible rack system.

This application claims priority under 35 U.S.C. ¶119 (e) of U.S. provisional application U.S. Ser. No. 60/706,231 filed 08 Aug. 2005, the contents of which are incorporated herein by reference.

### FIELD OF INVENTION

The present invention relates to bicycle racks in general, and to a conversion member that may readily be used to convert an existing bicycle rack to a trailer-bike rack to transport a trailer-bike on the roof of a vehicle, such as an automobile. The conversion member may easily be removed and/or folded to reconvert the trailer-bike rack to an ordinary rack.

### BACKGROUND

Bicycle racks that are mounted on the roof of automobiles are known. However, prior art racks work well only for carrying ordinary bicycles. They are not suitable for carrying trailer-bikes.

One type of a commonly used rack 10 is shown in FIG. 1. The rack can be attached to the roof of an automobile or a car 20 in a number of ways depending upon the roof structure of the car, and as they are not significant to the invention, they are not described in detail here in order not to unnecessarily obscure the present invention.

In the system shown in FIG. 1, the rack comprises a wheel-channel, hereafter referred to as a rail 30 which is mounted onto two cross bars 40, which in turn are secured onto the roof bars 50 of the car by means of damps 60. The tires 75 of a bicycle 70 are placed on a rail 30 and the body 80 of the bicycle is fixedly secured to the rack by a rod-clamp combination, hereafter referred to as a yoke 90, while the tires are further secured to rail 30 by means of straps 95. It may be possible to mount more than one rail 30 onto rack 10 in order to accommodate more than one bicycle on the rack, depending upon the size of the bicycles and considerations of safety.

FIG. 2 shows a trailer-bike 100 in tow with an ordinary tow-bicycle 70, also shown in FIG. 1. Trailer-bikes as shown in FIG. 2 are known and will not be described in detail here so as to not obscure the present invention. It will readily be evident that the bicycle/trailer-bike combination cannot be accommodated on a roof rack as they are too long to fit on the roof of an ordinary automobile. Even if it did, such as on a larger vehicle, the trailer-bike may not be stabilized for safe travel. There is, therefore, a need to be able to easily and quickly convert an existing bicycle rack to accept a trailer-bike to safely transport on a car and preferably, along with the tow-bicycle as well.

### REFERENCES

U.S. Pat. No. 6,460,743 describes an apparatus and method for transporting a bicycle in a substantially upright orientation. The method includes positioning a bicycle in a carrier so that a wheel of the bicycle is located in a trap space of the carrier. The trap space is configured to maintain the bicycle in a substantially upright orientation when the wheel is located therein and the carrier is in a released configuration. This permits the operator to use both hands to secure the bicycle in the carrier. The wheel of the bicycle, and typically the front wheel, is fixed in the carrier by applying a squeeze force upon the wheel and thereby establishing a securing configuration of the carrier. Preferably, the squeeze force is imposed across a perimeter of the wheel and the actuators for imposing the squeeze force are positioned low enough to be within the typical user's reach, also referred to as the reach zone, when the carrier is mounted on the roof-top of a carrying vehicle.

Another U.S. Pat. No. 5,655,696 shows a bicycle rack with a substantially planar carrier surface extending in the longitudinal direction, longitudinal frame members, whereby the carrier surface is adapted to be modified at least in one of size and configuration by the use of cross rail assemblies forming tubular members and extending substantially transversely to the longitudinal direction and of support arms rotatable as well as axially adjustable within the tubular members; the support arms can be held fast in a preselected axial and rotatable position, whereby the frame members are so arranged that the maximum height of the cross rail assemblies lies substantially within the plane of the carrier surface.

Still another U.S. Pat. No. 5,871,131 describes a bicycle rack for supporting bicycles in an upward standing position at the back end of a vehicle with the bicycles standing in a substantially vertical position angled horizontally at the back end of the vehicle. The trailer hitch sleeve mounted bicycle rack supports bicycles, each in an upward standing position on a center support post. The bicycle rack includes a base member of which a tongue portion slides into a trailer hitch sleeve. An adjustable sliding member slides onto the base member. A vertical support post is affixed to the sliding member. A series of horizontal trays angled from the base of the vertical support post, and a series of bicycle front fork mounts at the top of the vertical support post. The horizontal trays receive a portion of the rear wheel of a bicycle so as to cradle the wheel and support the bicycle. Bicycles stand upwardly from the rear wheel support trays angled from the base of the vertical support post at the rear of the vehicle.

Still another U.S. Pat. No. 6,575,344 discloses a bicycle rack for supporting a bicycle having an attachment mount member configured for coupling to a transport vehicle. A support assembly is connected to the attachment mount member and is configured to hold a wheel of the bicycle. A vertical support beam is connected at a first end to the support assembly. When the bicycle rack is used to transport a bicycle, the vertical support beam is stationary relative to the support assembly. A seat anchoring assembly is attached at a second end of the vertical support beam and is configured to hold a portion of a set of the bicycle.

U.S. Pat. No. 6,915,999 describes a connection member connected to a bicycle rack at an engaging plate on a top of the connection member and a through hole defined through the connection member. A polygonal wall extends from a side of the connection member and encloses the through hole. A rectangular extension tube is connected to a vehicle and is inserted through the through hole. Bolts extend through the polygonal wall and are engaged with the extension tube.

The contents of the entire prior art references cited herein are incorporated by reference.

### SUMMARY

Disclosed herein includes

a conversion support member configured to attach to a bicycle rack, wherein the conversion support member converts the bicycle rack to a trailer-bike carrier;

a conversion support member configured to modify a Thule™ bicycle rack to accommodate a bicycle having two wheels and a trailer-bike having one wheel and an arm, to be carried together on the same rack, the Thule™ bicycle rack having one or more channel rails onto at least one of which the bicycle can be mounted, onto another of which the trailer-bike can be mounted, wherein the support member is attached to the channel rail onto which the trail-bike is attached to provide support to the arm of the trail-bike;

a convertible rack system configured to carry one or more bicycles and associated trailer-bikes together on the same rack, the rack system having a conversion support member to secure the trailer-bikes.

Disclosed herein also include aspects of an embodiment of the present invention to:

provide a conversion support member configured to removably attach to a bicycle rack;

provide a conversion support member configured to foldably attach to a bicycle rack;

provide a conversion support member configured to fixedly attach to a bicycle rack.

### BRIEF DESCRIPTION OF DRAWINGS

FIG. 1 shows a bicycle mounted onto a bicycle rack on the roof of an automobile, according to prior art.

FIG. 2 shows a trailer-bike being towed by a bicycle, according to prior art.

FIG. 3 shows an enlarged view of a Thule™ bicycle rack FIG. 1, according to prior art.

FIG. 4 is an embodiment showing a conversion member of the present invention used to convert a conventional bicycle rack to carry a trailer-bike.

FIG. 5 shows an aspect of an embodiment of FIG. 4 in securing a trailer-bike to a converted rack, using the conversion member of the present invention.

FIG. 6 shows another embodiment of the conversion member of the present invention.

FIG. 7 shows a rack system that accommodates the mounting of a towing-bicycle and a trailer-bike on the same roof-top of a vehicle by using the conversion member of the present invention.

### DETAILED DESCRIPTION

In embodiments there is illustrated:

a conversion member for converting a bicycle rack into a trailer-bike rack to carry a trailer-bike on the roof of a vehicle, such as an automobile. The conversion member may also be used to convert a bicycle rack to carry both the towing bicycle and its associated trailer-bike together on the same combination convertible rack. The conversion member may be provided as an integral part of a combination rack for use on, tough not limited to, the roof of an automobile.

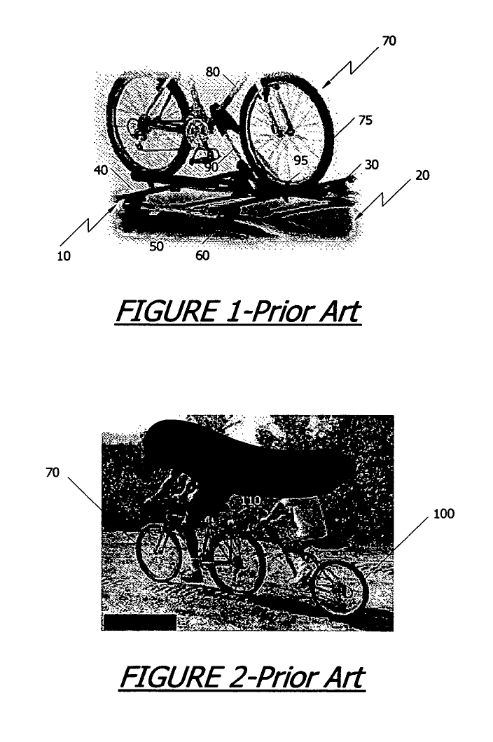

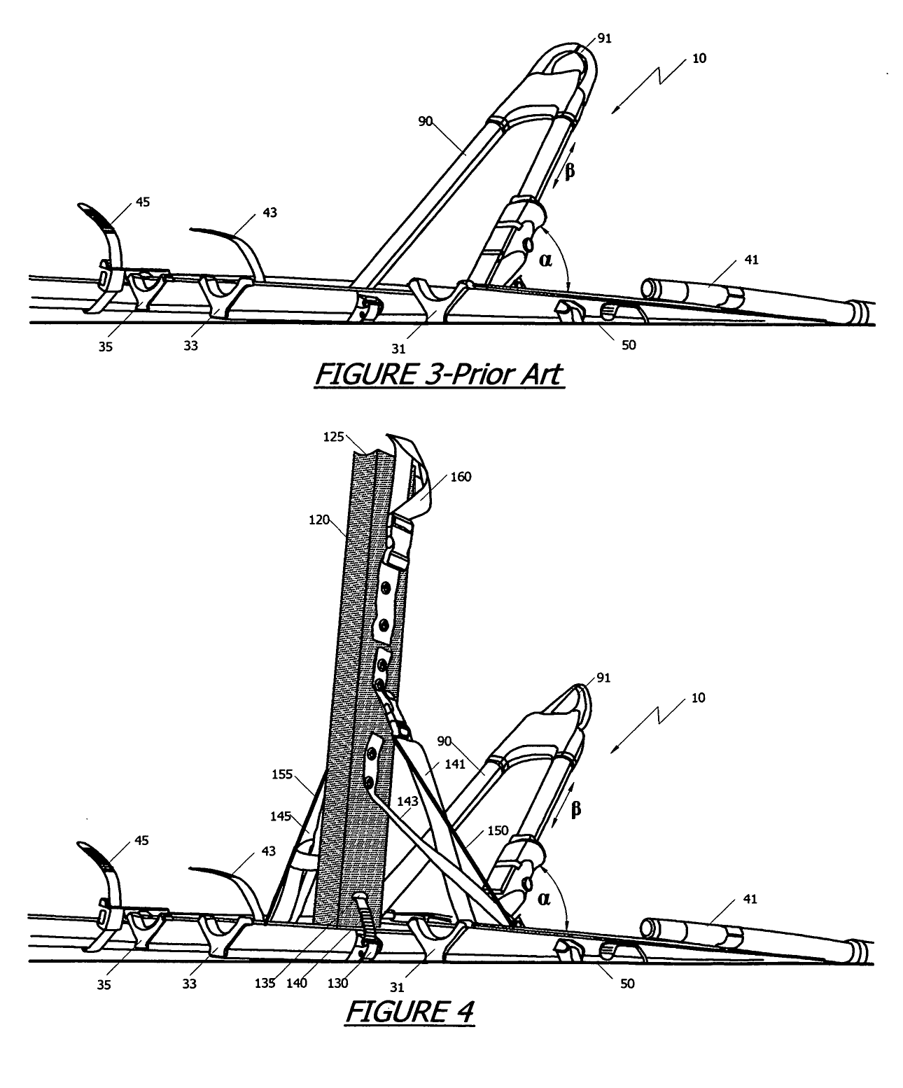

Now referring to the drawings, FIG. 3 shows a portion of a Thule™ rack mounted on the roof of a car as shown in FIG. 1. Thule™ is used as an exemplary bicycle rack, and it will be understood that other racks could have been used for illustrative purposes. With reference numerals referring to similar parts as in FIG. 1, rack 10 is held onto the partially shown roof bar 50 of an automobile by attachment means 41 and/or fasteners 43 and 45.

Rack 10 has three identical channels or rails 31, 33, 35 which accept the front and rear wheels of a bicycle in a configuration such as shown in FIG. 1. Each rail may be used to mount a bicycle, thus making it possible to carry three bicycles (not shown), depending upon their sizes. Each rail has a U-shaped yoke 90 with a claw or clamp 91 (as shown in FIG. 3) which secures the body 80 (shown in FIG. 1) of the bicycle to the rack 10. Yoke 90 can rotate at angle a and extend in the direction of β to accommodate different types of bicycles having different bodies 80 of different diameters and lengths.

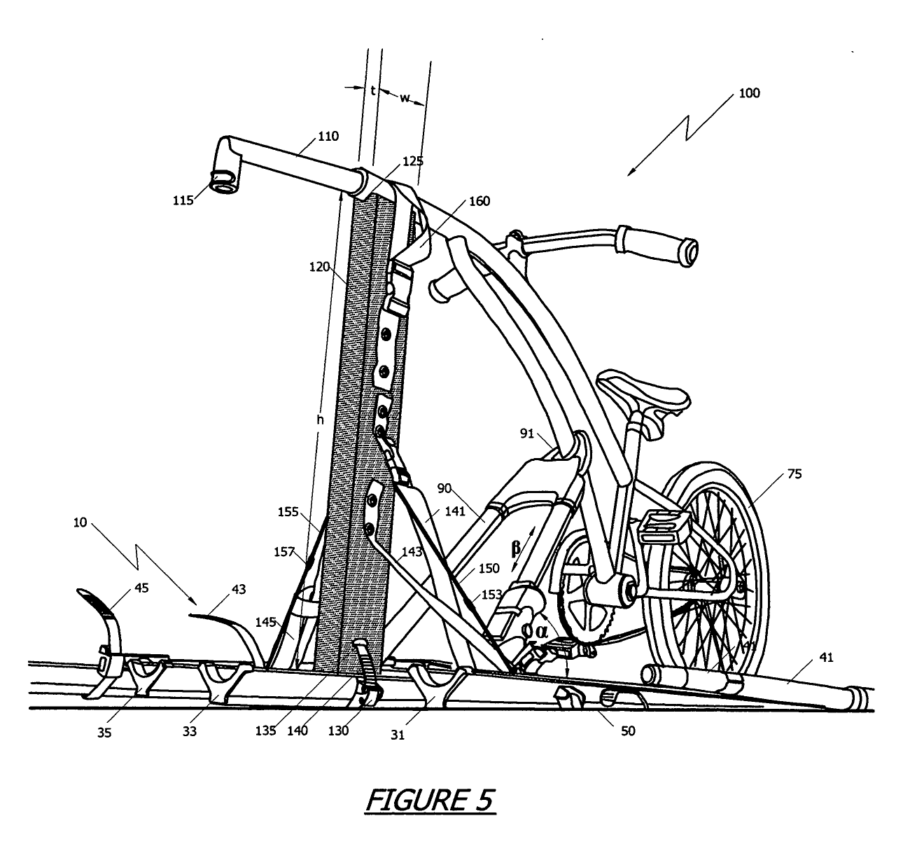

It will be appreciated that rack 10 shown in FIGS. 1 and 3 is configured to secure a bicycle with two wheels that are strapped onto rails 30 and a body that can be clamped in yoke 90. When trailer-bike 100 of FIG. 2 is disassembled from its tow-bicycle 70, although its one wheel 75 can be placed on one of the rails on rack 10, its arm 110 seen in FIG. 2 does not have any place to be secured to. A trailer-bike with a slightly different type of arm 110 is better seen in FIG. 5. Arm 110 shown in the same FIG. 5 has a connector 115 that attaches to a mating part on the rear of the towing bicycle (not shown).

An embodiment of the present invention involves a support member 120 which is capable of converting a bicycle rack into a trailer-bike rack in the following manner; in an aspect, the conversion member 120 has a thickness commensurate to fit inside one of the rails 30 and height to provide a resting post for arm 120, thus providing a means for securing the trailer-bike firmly onto the rack. The conversion member 120 may be secured to rack 10 in a number of ways, including, but not limited to erecting it vertically in one of the rails while strapping 140 it to an existing support 130 through an opening 135 provided in the conversion member. Additionally, one or more straps, such as 141, 143 and 145 shown in FIG. 4 may be judiciously affixed to the conversion member 120 and secured to the existing rack parts. Furthermore, the conversion member may be further strengthened by means of guy wires 150 and 155. For the exemplary Thuler™ rack shown in FIG. 1-5, a working prototype model of the conversion member 120 has the preferred dimensions of height, h, from about 25¾ to 26¼ inches, width, w, from about 3 to 3½ inches, and thickness, t, from about 1 inch to about 1¼ inches, tapering down to from about ⅞ to about 1 inch to fit inside rails 31, 33 or 35. The conversion member may comprise wood or metal, preferably aluminum or anodized aluminum.

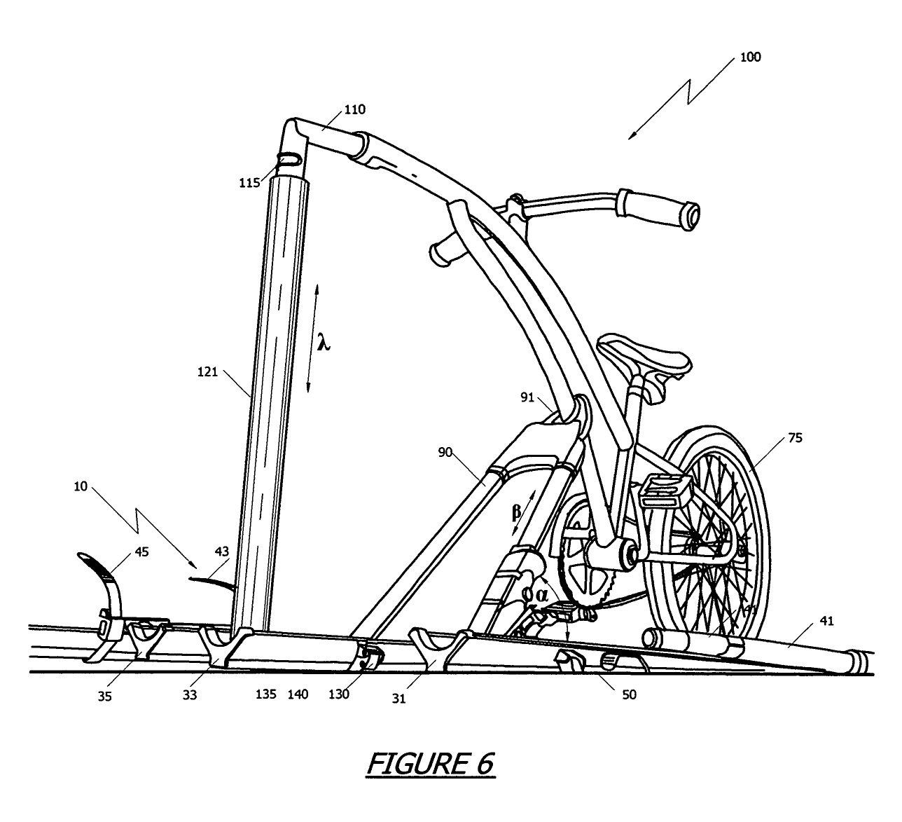

In another aspect of an embodiment, the conversion member 120 may comprise a telescopic component, shown illustratively as λ, which may be used readily to adjust the height h of the conversion member 120 to meet the arm 110 of any trailer-bike that is mountable on rack 10, as better seen in FIG. 6. It will be noted that the conversion member of any polygonal or cylindrical shape. Furthermore, the arm 110 of the trailer-bike 100 may be of any other shape and length for which the conversion member 120 may be modified to accommodate the arm 110. The top portion 125 of the conversion member may be shaped and also padded to provide a good seating for arm 110 on member 120. Arm 110 may be tightly secured to the top portion 125 in any number of ways, including, but not limited to using a strap 160, which is better seen in FIG. 5. Top portion 125 may be formed in semicircular shape to accept the cylindrical portion of the arm 110 as shown in FIG. 5.

In another embodiment, the conversion member 120 of the present invention may be incorporated into and provided with a rack where the conversion member 120 may be permanently fixed into side rail 35 shown in FIG. 5 such that the other rails 33 and 35 may be used to mount the tow bicycle, or other bicycles for transporting on a vehicle, such as an automobile.

Yet another embodiment involves a conversion member 120 of the present invention incorporated into and provided with a combination rack where the conversion member 120 may be hinged into rail 31 shown in FIG. 5 such that when not in use, the member may be folded into the rail for self storage while relinquishing its rail to carrying a regular bicycle. Guy-wires 150 and 155 may then be unhooked and also stored alongside the conversion member in its rail 33. A combination of bicycles and a trailer-bike may then be transported together on the same combination rack.

In operation, a method of mounting a trailer-bike 100 onto a combination rack 10 involves first erecting the foldable conversion member 120 vertically and installing the guy-wires 150 and 155 from the conversion member 120 onto a pair of hooks (not shown) on the combination rack 10. Then the trailer-bike is lifted up to the combination rack 10 on the roof of car 120, such as shown in FIG. 1 and wheel 75 placed onto one of the rails, say, rail 33 while lowering the arm 110 of the trailer-bike 100 onto the top portion 125 of the conversion member 120. The method further involves strapping (160) the arm 110 of the trailer-bike 100 to the top portion 125 of the conversion member 120. If need be, guy-wires 150 and 155 may then be tightened by means of turn-buckles 153 and 157 mounted onto the guy-wires 150 and 155, respectively, for additional security. As a final safety measure, the conversion member 1210 may be fastened to the rack by means of straps 141 and 143.

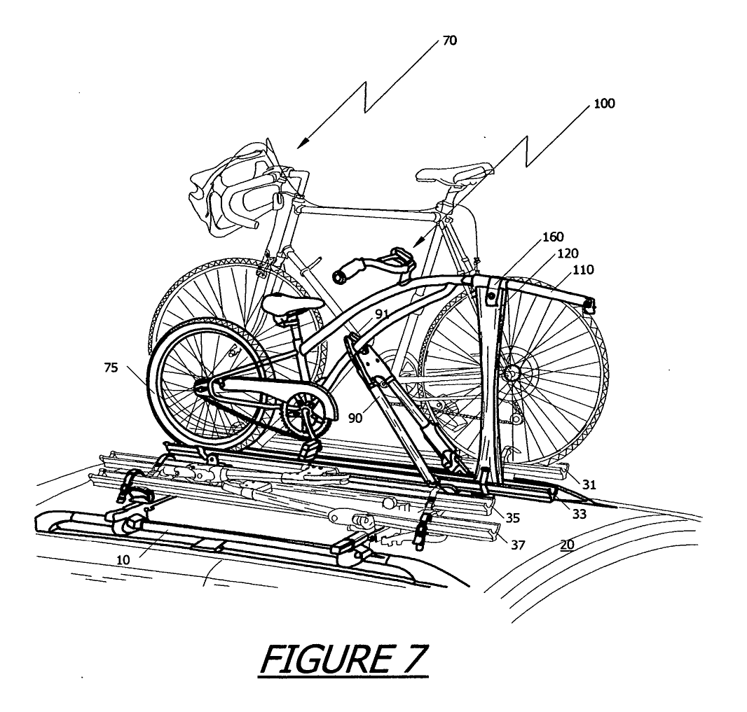

FIG. 7 shows a rack system for carrying a trailer-bike incorporating the mounting of both the tow-bicycle 70 and the trailer-bike 100 on the same roof-top 20 of a vehicle. It will be noted that bicycle 70 and trail-bike 100 can be mounted conveniently on any one of the four channel rails, 31, 33, 35 and 37. Bicycle 70 is shown to be mounted on rail 31, while the trail-bike is mounted on rail 33. The bicycle 30 is shown in phantom so as to not obscure the presentation of the trailer-bike 100 on the rack system 10. The wheel 75 of the trailer-bike 100 rests in rail 33, while the arm 110 of the trail-bike 100 rests on conversion member 120, which is schematically streamlined for least resistance to wind. Arm 110 is secured tightly onto conversion member 120 by means of strap 160 while the conversion member itself is held upright in channel rail 33 by means of strap 130. For additional stability, guy wires may be used as described previously and not shown here. Furthermore, the body of the trailer-bike 100 is firmly secured by clamp 91 of yoke 90, as shown in FIG. 7 The body of the tow-bicycle 70, shown in phantom, is likewise secured to its own yoke (hidden behind yoke 90 of the trailer-bike 100), and by tie-down straps securing the tires to channel 31. It will be noted that it is not necessary to tie-down tire 75 of the trailer-bike 100, as the yoke 90 and the conversion member 120 of the present invention provide the necessary stability and safety.

Though these numerous details of the disclosed apparatus and method are set forth here, such as physical dimensions of the conversion member and steps of erecting the same, to provide an understanding of the present invention, it will be obvious, however, to those skilled in the art that these specific details need not be employed to practice the present invention. At the same time, it will be evident that the same methods may be employed in other similar methods of loading a trailer-bike onto the rack of the present invention, that are too many to cite, such as first lifting the trailer-bike to the rack and then lifting up the conversion member from its storage railing to support the arm of the trailer-bike from underneath the arm.

That is, while the invention has been particularly shown and described with reference to a particular embodiment(s), it will be appreciated that variations of the above-disclosed embodiment(s) and other features and function, or alternatives thereof, may be desirably combined into many other different systems or applications Also that various presently unforeseen and unanticipated alternatives, modifications, variations or improvements therein may be subsequently made by those skilled in the art which are also intended to be encompassed by the following claims.

What is claimed is:

1. An apparatus comprising
a conversion support member configured to attach to a bicycle rack, wherein the conversion support member converts the bicycle rack to a trailer-bike carrier.

2. The apparatus according to claim 1, wherein the bicycle rack comprises a channel rail to receive the wheels of the trailer-bike.

3. The apparatus according to claim 1, wherein the bicycle rack comprises a yoke to secure the body of the trailer-bike.

4. The apparatus according to claim 1, wherein the conversion support member is removably attached to the rail of the bicycle rack.

5. The apparatus according to claim 1, wherein the conversion support member is foldably attached to the rail of the bicycle rack.

6. The apparatus according to claim 1, wherein the conversion support member is fixedly attached to the rail of the bicycle rack.

7. An apparatus comprising
a conversion support member configured to modify a Thule™ bicycle rack to accommodate a bicycle having two wheels and a trailer-bike having one wheel and an arm, to be carried together on the same rack, the Thule™ bicycle rack having one or more channel rails on to at least one of which the bicycle can be mounted, onto another of which the trailer-bike can be mounted;
wherein the support member is attached to the channel rail onto which the trail-bike is attached to provide support to the arm of the trail-bike.

8. The apparatus according to claim 7, wherein the conversion support member is removably attached to one of the channel rails of the Thule™ bicycle rack to secure.

9. The apparatus according to claim 7, wherein the conversion support member is foldably attached to one of the rails of the Thule™ bicycle rack.

10. The apparatus according to claim 7, wherein the conversion support member is fixedly attached to one of the rails of the Thule™ bicycle rack.

11. An apparatus comprising
a convertible rack system configured to carry one or more bicycles and associated trailer-bikes together on the same rack, the rack system having a conversion support member to secure the trailer-bikes.

12. The apparatus according to claim 11, wherein the rack system comprises one or more channel rails to receive the wheels of one or more bicycles.

13. The apparatus according to claim 11, wherein the rack system comprises one or more channel rails to receive the wheel of one or more trailer-bikes.

14. The apparatus according to claim 11, wherein the rack system comprises one or more yokes to secure the body of the one or more bicycles.

15. The apparatus according to claim 11, wherein the rack system comprises one or more yokes to secure the body of the one or more trailer-bikes.

16. The apparatus according to claim 11, wherein the conversion support member is removably attached to the one or more rails of the bicycle rack.

17. The apparatus according to claim 11, wherein the conversion support member is foldably attached to the one or more rails of the bicycle rack.

18. The apparatus according to claim 11, wherein the conversion support member is fixedly attached to the one or more rails of the bicycle rack.

19. The apparatus according to claim 11, wherein the conversion support member comprises a light-weight material including aluminum, streamlined to minimize wind resistance.
